(19) United States
(12) Patent Application Publication
(10) Pub. No.: US 2010/0122529 A1
(43) Pub. Date: May 20, 2010

(54) Kinetically balanced bi-direction rotational wave energy converter

(76) Inventor: William Steven Kroll, Houston, TX (US)

Correspondence Address: William Steven Kroll, 5118 Contour Pl., Houston, TX, 77096, US

(21) Appl. No.: 12/313,043

(22) Filed: Nov. 17, 2008

(51) Int. Cl. F03B 13/18

(52) U.S. Cl. 60/504

(57) ABSTRACT

An improved apparatus and method to extract the mechanical energy of waves, tides and water movement into useful mechanical energy, a wave energy converter (WEC). This device is easily scaled to harness said energy according to the needs of local conditions or user requirements. It has five elements, to be placed in a body of water. Two of those elements being a buoyant body, containing an apparatus for water motion energy conversion, and a reactive free weight being able to move relative to each other in response to forces exerted by the body of water. A mooring system, to which, is attached a flexible member. The flexible member attaches these elements together as one device. Upon its length it contains at least two re-positionable elements which restrain the motion of the buoyant body along the length of the flexible member.

### BACKGROUND OF THE INVENTION

This invention relates to the conversion of energy from naturally occurring sources of mechanical energy, particularly the mechanical energy present in ocean surface waves and tides.

Various wave energy converter (WEC) systems are known. Some of the earliest were simple paddlewheels; others were floatation devices mounted to permanent structures. Most of these WEC systems incorporate the requirement of a permanent stationary oceanfront bulkhead or seabed component. The primary drawback of these devices, notwithstanding their efficiency or lack thereof, is their permanent stationary nature. Because individuals cannot own public waters, such installations require special government permissions, such as leases and/or environmental impact waivers.

Other systems for converting the mechanical energy potential of the ocean utilize hydraulic systems. Particularly, the potential for deleterious environmental impact may occur wherein organic or synthetic hydraulic fluid systems are utilized. Said fluids may escape the primarily closed nature of these systems and cause environmental pollutants adversely effecting sea life, beach quality and those coming into contact with primary or secondary pollutants.

Other systems have been designed utilizing seawater as a hydraulic fluid. In this regard, seawater is a relatively inefficient energy transfer medium, which is also highly corrosive. The designer must utilize non-ferrous materials within the design, leading not only to higher initial costs but also to the higher probability of theft of the device. Being a device in open water, it is vulnerable to thievery. Including a large volume of high value base materials increases the likelihood that the devices will be targeted for theft.

Others designs utilize seawater for its potential kinetic energy by pumping via WECs it to a higher elevation for use in turbines. While this design has a proven efficiency, it has the same drawbacks of other devices requiring permanent locations i.e.: government permissions. Further, it requires specific site requirements wherein a cliff with sufficient elevation and a plateau for collections and storage in pools or tanks is included within economical distance.

Floating buoy devices have also been put forward as valid design concepts. While their portability makes them attractive, many utilize only the linear bobbing motion of the buoy as their source of locomotion for the conversion of wave force. To accomplish this, many utilize a linear electric generator (LEG) as their method of energy conversion. Linear generators have yet to prove themselves as reliable or efficient generators of electrical power. Further, their use high value rare earth magnetics makes for a high initial cost.

Other designs utilize pressure conversion. These designs occur in free-floating, bulkhead and permanent sea floor installation designs. These systems convert water pressure to air pressure, which is then used to power a turbine. Bi-directional turbines, such as the well-known Wells turbine, are often incorporated within these designs. The primary drawback, however, is that the Wells turbine has a very low efficiency.

We have also seen designs that have utilized the vertical axis turbine (VAT) concept. These are most familiar for the conversion of wind to electrical output. Here again, this design requires a permanent installation. The VAT, a.k.a.: “vertical axis turbine” must be placed in sufficiently deep waters so as to avoid being a navigation hazard. Servicing such systems becomes difficult and expensive as all primary mechanisms are at deep ocean depths in areas of high velocity ocean current. Further environmental impact studies may reveal additional constraints for the system's applicability in real world applications.

Other iterations of the WEC concept have included floats that travel with currents or are driven by the force of surface waves. These units often convert the motion of travel by linear translation along a flexible member constraining their travel. These devices fail to utilize the foremost power of the wave, which is torque. Therefore, even their theoretical efficiency is quite low.

Other systems for ocean wave energy conversion include multi-segmented devices, which utilize differential movement between the segments as their moment force for primary energy conversion. These systems often rely on hydraulics to make their conversion and I have, in the aforementioned text, referred to the potential drawbacks of such systems. These systems, it should be said, also rely upon the mass of the segments. This makes them bulky and expensive. Large-scale deployment of such systems in an area of high-density ocean energy may also, by their nature, result in a decline of the potential energy available by constraining the surface energy available.

Still other designs have proposed thin-walled flexible structures designed to (primarily) float on the surface and translate the water's motion into an accelerated/concentrated energy state, often captured by a turbine generator or pump of one sort or another. Those proposing such designs have ignored the unforgiving nature of the sea Such delicate systems would be vulnerable to damage by storms and/or unexpected sea conditions.

Other designers, seeking to improve existing WEC designs through the utilization of computer algorithms and controls, have proposed many designs. While such efforts are justifiable, they ignore the primary means of systems improvement. This primary means, we believe, is a primarily different mechanical means of motion translation. They instead, rely upon inefficient design criteria that were determined through self-proclamation. Their “improvements” rely upon an unproven hypothesis which effectively states that mechanical systems cannot self-regulate.

This current design overcomes the many drawbacks as described in this writing with an improved mechanical translator of ocean energy extraction.

### FIELD OF INVENTION

The present invention relates to alternative forms of energy production. Specifically, it is a means of translating the bi-directional vertical motion of waveforms, and their progressive forward progression into useful rotary motion. The wave energy conversion methods associated with this system, as described herein, should be familiar to those knowledgeable in the art.

### SUMMARY OF THE INVENTION

Applicants' invention allows a method of energy extraction of ocean surface waves and water motions by means of a freely moving weight attached to a buoyant body via a rotating cylindrical body contained in same. A mooring system, either permanent or temporary has a flexible member attached to it, which links the elements together. Employing the kinetic energy stored in a free weight attached to the end of a flexible member allows the buoyant member of the system to re-orient itself between wave crests and troughs as well as high and low tidal periods. Said free weight also provides an additional means of extracting energy through the free weight's mass rather than relying upon the mass of the buoyant body, as found in many previous WEC flotation systems.

The invention described herein utilizes the mass of the free weight as a prime mover within the system. As described, said weight may be scaled in accordance with the buoyancy of the shell containing the mechanical means of ocean energy extraction. Through such a method, the system may be scaled to extract a pre-determined maximum amount of energy. This enables the system scale to be kept within the energy potential of the particular site in which it is to be located.

This system allows the WEC to be deployed and utilized wherever the anchoring of a vessel is allowed. This system may be easily towed, or a secondary method of propulsion for its movement may be employed when circumstances for its relocation are required. While the system is robust in nature, history has proven that no vessel or structure is immune to nature's destructive effects. Therefore, its navigational ability is an important portion of one embodiment of the system.

My system's method of transference of ocean energy, through the system's rotating mechanical elements, is an efficient, proven and pollution free method of ocean energy extraction. Said method has minimal environmental impact. Through selective construction materials choices, the design is sustainable and without deleterious effects on the environment.

A WEC embodying the invention includes a buoyant shell (hull, shell) and a tethered free weight which are designed to move relative to each other to convert the force of the water's motion into mechanical energy. In the discussion to follow, the shell and weight are generally depicted or referred to as the moving members and the mooring as the non-moving or mechanically grounded member. But, the opposite may be the case and both the weight and shell may move relative to each other. The WEC includes a power-take-off device (PTO) coupled between the shell and the weight to convert the mechanical power available from the WEC into useful energy. This is the desired output that is to be produced as efficiently as possible through a convenient means applicable to the circumstances in which the WEC is placed.

Applicants' invention resides, in part, in the use of apparatus and methods for increasing the effective motion, velocity and acceleration of the shell to increase the power available from the WEC and the viable output from its coupled PTO. According to one aspect of the invention, the motion and velocity of the shell is increased by the reaction of the free weight during portions of a wave cycle.

The invention also claims that the neutrally buoyant flexible member has a material nature which acts much as a spring does in that the recoverable stretch available, within same, enhances the relative motion between the elements of the system.

### BRIEF DESCRIPTION OF THE DRAWINGS

FIG. 1. Is a side view of one embodiment of a deployed apparatus.

FIG. 2. Describes the devices which translate bi-directional rotary motion into single-direction rotary motion(s).

FIG. 3. Is a top view of one preferred embodiment of the mechanical design.

FIG. 4. Illustrates the progressive oscillation of waveforms and their associated under water motion.

FIG. 5. Is a simplified side view description of the invention's primary interactions with the progressive oscillation of waveforms, including reactions with the wave fronts.

### DETAILED DESCRIPTION OF THE DRAWINGS

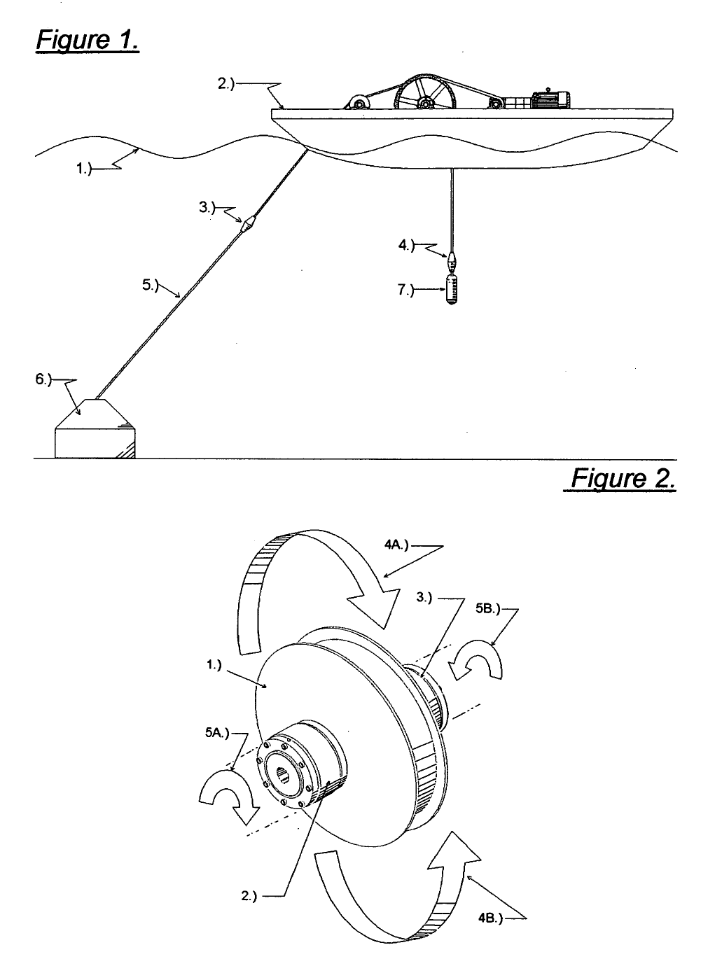

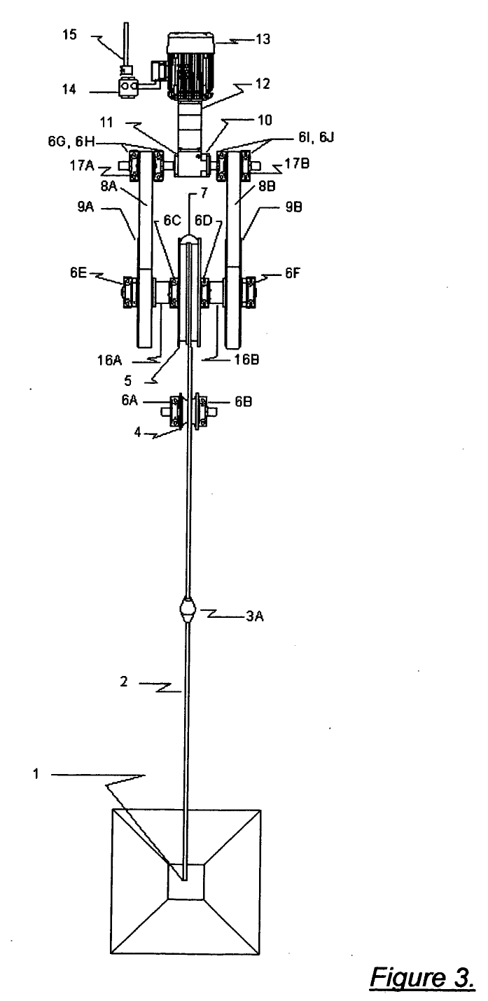

Referring to FIG. 1, a preferred embodiment of the Kinetically Balanced Wave Energy Converter described herein, indicated generally at reference numeral 1 is the depiction of a body of water, as referenced at numeral 1, at its surface. A buoyant shell, as referred to at numeral 2, containing the apparatus of wave energy conversion (referenced in FIG. 3, and detailed in FIG. 2) is located in said body of water (1) along with its associated apparatus.

The buoyant shell (2) is held between a mooring point (6) and a free weight (7) by means of a flexible member (5). Its range of motion along the length of the flexible member (5) may be restrained by means of mechanical stops, referring to numeral 3 and 4. As illustrated, the buoyant body's (2) motion is restrained directionally towards the mooring (6) by the mechanical stop as referenced by numeral 3. The reversed motion is controlled by means of mechanical stop as reference by numeral 4.

Referring to FIG. 2, we illustrate the preferred embodiment of the mechanical apparatus that translate the bi-directional motion of the lightweight cylindrical body, as referenced by numeral 1, into a duality of rotary output motions, each of a single direction. The freewheel motion translators are indicated by numerals 5A and 5B. Not shown in this figure, is the flexible member, shown in FIG. 1, as indicated by numeral 5, which is wrapped around the lightweight cylindrical body.

The freewheel device indicated as numeral 2, accepts motion in a clockwise direction only as indicated by numeral 5A. As its driving force from the lightweight cylindrical body (1) reverses direction, it goes into freewheeling mode, which is a continuation of its clockwise driven rotation as indicated by numeral 4A.

The freewheel device indicated as numeral 3, accepts motion in a counter-clockwise direction only as indicated by numeral 5B. As its driving force from the lightweight cylindrical body (1) reverses direction, it goes into freewheeling mode, which is a continuation of its counter-clockwise driven rotation as indicated by numeral 4B.

Referring to FIG. 3, we illustrate a top view of the preferred embodiment of the wave energy converter without the presence of a buoyant body or shell (as indicated in FIG. 1 by numeral 2). This is done for purposes of visual clarity when referencing the components herein: A mooring point is indicated by numeral 1. As shown in the preferred embodiment, we represent this mooring as a sea floor anchor point. In another preferred embodiment, the mooring point may be located on shore or another water born vessel. Attached to the mooring point (1) is a flexible member as indicated by numeral 2. The length of this flexible member (2) shall be selected based upon the body of water in which the WEC is placed. The diameter and length of this flexible member (2) shall be selected based upon both the size of the WEC and the actions of the body of water in which the WEC is placed. In the preferred embodiment the flexible member (2) shall be composed of material(s) that are of a substantially, neutral buoyancy and shall possess a quality which imparts and has substantial recoverable stretch along length. On the end opposite of the mooring point (1) we see an attached free weight as referred to as numeral 7. In this preferred embodiment we represent the flexible member (2) terminating its length at the attachment point of the free weight (7). In another preferred embodiment, said free weight (7) may be located at any point aft of the aft mechanical stop as referred to numeral 3B.

Mechanical stops are provided for along the flexible member as indicated by numeral 3A and 3B (not viewable). The placement of these stops is selectable by the user as water conditions suggest. The forward mechanical stop (3A) is located between the bow of the buoyant body and the mooring point (1) while the aft mechanical stop (3B) is located between the stern of the buoyant body and the free weight as indicated by numeral 7.

A guide for the flexible member's (2) entry into the buoyant body is provided for, as indicated by numeral 4. It is supported by anti-friction bearings as indicated by numerals 6A and 6B. Said guide (4) assures proper alignment of the flexible member (2) with the low-mass cylindrical body as indicated by numeral 5. This alignment allows for required contact of the flexible member (2) with the axial face of said low-mass cylindrical body (5).

As used herein, the term “low-mass” represents a differential of mass and/or weight between components as described in this article.

A condition of low mass and light weight are desirable properties of the low-mass cylindrical body (5) because said element will continuously reverse its direction of rotation in response to inputs by the flexible member (2). In the preferred embodiment of the invention, this element's ability to rapidly reverse direction in response to power input by the interaction between the flexible member (2) and the low-mass cylindrical body (5) is an important condition of its efficiency of energy capture and conversion. Free rotation of the low-mass cylindrical body (5) is enhanced through the support of anti-friction bearings as referred to in numerals 6C and 6D. The bi-directional rotational motion of the low-mass cylindrical body (5) is translated by freewheel devices as referred to in numerals 16A and 16B. Said freewheel devices each accepting input of rotational energy from the low-mass cylindrical body (5) in only one direction. One freewheel device (16A) being provided for clockwise motion and another freewheel device (16B) shall be provided for counter-clockwise rotary motion. Said freewheels (16A, 16B) being located on opposite sides of the low-mass cylindrical body (5) and sharing the same axis of rotation.

A means of attachment provides an output of rotational energy to the flywheels as referred to in numerals 9A and 9B. In the preferred embodiment, these flywheels (9A, 9B) rotate in opposite directions of rotation, one flywheel (9A) having been imparted a clockwise rotation and flywheel 9B therefore having an opposite counter-clockwise rotational direction. In another preferred embodiment, the direction of rotation may be reversed between flywheels 9A and 9B. In the preferred embodiment, the flywheels (9A, 9B) have a periphery surface, which is formed in such a manner as to engage a drive a belt about its circumference. In another preferred embodiment said periphery surface area may have a method of gearing. Another preferred embodiment, the freewheels (9A, 9B) may have a substantially smooth periphery surface structure.

In the preferred embodiment the rotational velocity of the flywheels (9A, 9B) is substantially the same as that of the low-mass cylindrical body (5). Another preferred embodiment of the device shall include a means for changing the velocity of the flywheels (9A, 9B) as said velocity relates to that of the low-mass cylindrical body (5). In another preferred embodiment of the invention, the flywheels (9A, 9B) may be located within mechanical housings designed in a manner that will reduce the aerodynamic drag upon the flywheels (9A, 9B). The rotation of the flywheels (9A, 9B) is enhanced through the use of anti-friction bearings (6E, 6F), intended to reduce the mechanical friction of the flywheels' (9A, 9B) axis of rotation. Said anti-friction bearings (6E, 6F) shall also serve, as either passive or active, means for controlling the radial and thrust characteristics of the flywheels' (9A, 9B) and for controlling the velocity of the flywheels' (9A, 0B) rotation. As well known, by those familiar in the art, said anti-friction bearings (6E, 6F) may be of a substantially mechanical, magnetic, electromagnetic, hydraulic, electro-hydraulic or pneumatic nature and their resultant designs. These various types of anti-friction bearings may include a means of control (or input) for their (enhanced) operation. Said input may be in the form of controls, which may be of a substantially digital, analog or mechanical nature or any combination of these same characteristics as described.

Conveying the energy held in the flywheels (9A, 9B), as illustrated in the preferred embodiment may take place in stages. As shown in numerals 8A and 8B, we see the use of cogged belting. These connect the flywheels (9A, 9B) to pulleys, as shown in numerals 17A and 17B. These pulleys (17A, 17B) may be of substantially smaller diameter than those of the flywheels (9A, 9B). This being an efficient method of rotational speed increase. Again, we employ the use of anti-friction bearings as shown in numerals 6G, 6H, 6I and 6J for the support of these pulleys (17A and 17B) and their enhanced low resistance rotation. These same anti-friction bearings, in the preferred embodiment, shall also support shafts that connect the pulleys to a speed-increasing transmission as referred to in numeral 11.

Because we have two directions of rotational output from the pulleys, it is desirous to employ the use of a reversing gear, referred to in numeral 10, on one driven side before it enters the speed-increasing transmission (11). Said transmission (11) may be of any convenient design available, including but not limited to, helical gearing, planetary geared, worm geared, pneumatic or hydraulic types.

In the preferred embodiment of the invention, we show in numeral 12, a rotational controller and/or clutch assembly. Said component would be desirable when the electrical generator unit, as referred to in numeral 13, requires a minimum input speed to operate efficiently.

The electrical generator (13) may be of any type or design. This would include, but not limited to the use of AC or DC generators as well as alternators. Within this realm, there is a great range of designs available to those familiar in the art.

In another embodiment of the invention the output rotation of the pulleys (17A, 17B) may be used separately. That is, a design in which two separate linkages and transmissions may be employed. This would cause the use of two transmissions and generators and would not necessarily require the use of any reverse gearing.

Another embodiment of the invention, the output of the pulleys (17A, 17B) is used to drive a hydraulic pump or pumps, rather than an electrical generator. In this scenario it may be desirable to utilize a hydraulic accumulator to maintain a more constant level of pressurization output within the system. The hydraulic energy of this system may be utilized to power an on-board electrical generator or transferred via conduit to shore or another vessel for distribution or direct utilization.

In another embodiment of the invention, the output rotational energy of the transmission (11) may be used to drive a high-speed flywheel for the intent purpose of energy storage.

In the preferred embodiment, conditioning of generated electricity is often desirable and this is addressed by employing the use of rectifiers, as referenced in numeral 14. The rectified electrical energy is then passed through an electrical conduit as referred to in numeral 15. Said conduit (15) may be of a weatherized nature so as to be placed into the body of water and exiting at a shore based station of another vessel for further distribution or direct use.

In another embodiment of the invention, the rectified electrical current may be directed by the conduit (15) to battery storage placed within the buoyant shell.

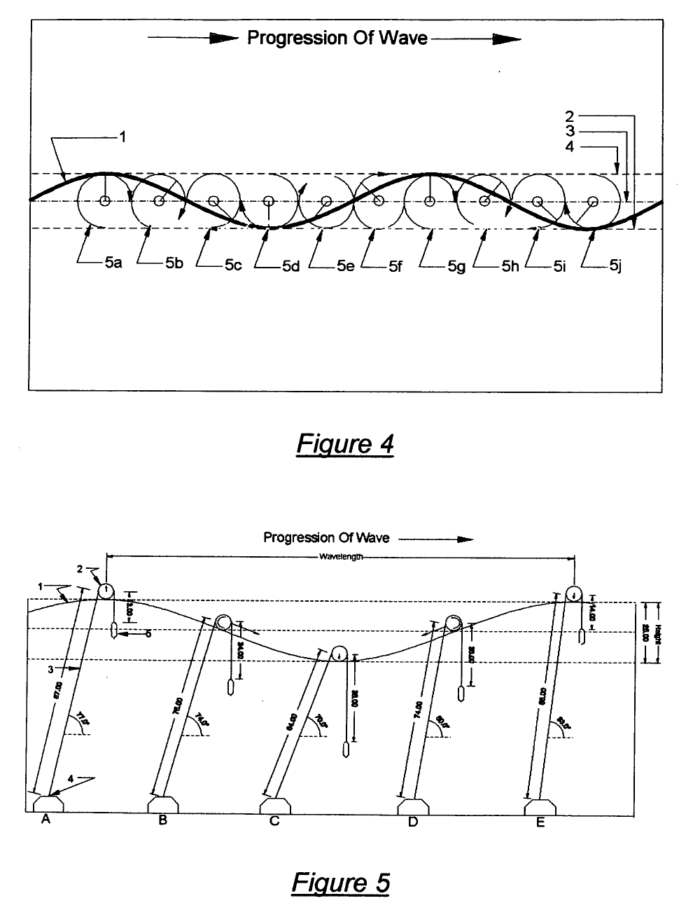

Referring to FIG. 4, we examine the nature of the water's motion as it relates to the progression of waves. Herein we witness that the pitch and fall of wave crests and troughs, is a reactionary process. That is, we observe Newtonian actions of events which are results of a prime mover. In normal conditions the primary mover is solar derived wind(s) imparting friction upon the water's surface resulting in a reaction of equal force. This process is essentially localized to the area of water receiving direct wind force, however, reactionary processes carry the waveform, in many instances, to distant areas. It is important to note that within the trough wave formation, a reverse of water motion (position referenced by numeral 5d) is observed as this is related to the motion of water within the waveform. Said reversal of motion assists the invention's buoyant body to recover its original linear positioning as this relates to the WEC's orientation upon the flexible member and within the constraints of the mechanical stops positioned upon same. The actual wave surface is referred to by numeral 1. The trough of the wave is represented by numeral 3. Sea level is referred to by numeral 3. The wave crest is represented by numeral 4. Motions of the water within the wave are referred to by numerals 5a through 5j. Each of these reactive motions (5a˜5j) within the wave may be considered as separate bodies of reactionary kinetic force which impart a rotational velocity to each adjacent area of the wave.

Referring to FIG. 5., the water's surface is indicated by the numeral 1. The low-mass cylindrical body is represented by numeral 2. The flexible member is referred to as numeral 3. The mooring point is referred to by numeral 4. The free weight is referred to at numeral 5.

Being a progressive representation we show several stages of the WEC as it reacts with a single wavelength from crest to crest. The crest points are represented as positions and are indicated by letters A and E. The trough of the waveform is referred to by letter C. Intermediate positions at mid-wave point are referred to by the letters B and D. Mid-wave point may also be referred to as sea level. The hydrodynamic drag of the buoyant shell, in this illustration, points to the need to minimize said drag upon the buoyant body to minimize the horizontal travel of the WEC, thus increasing its energy efficiency as the actual capture of energy is maximized by increased linear translation of motion as they relate to the flexible member (3) and the low-mass cylindrical body (2).

What is claimed is:

1. An improved apparatus and method to extract the mechanical energy of waves, tides and water movement into useful mechanical energy, a wave energy converter (WEC). This device is scaled to harness said energy according to the needs of local conditions or user requirements. It's elements are intended to be placed in a body of water. Two elements, a buoyant body containing the apparatus for water motion energy conversion and a reactive free weight being able to move relative to each other in response to forces by the body of water. A mooring system to which is attached a flexible member. The flexible member attaches these elements together as one device and on its length contains at least two movable elements which contain the motion of the buoyant body along the length of the flexible member.

2. The combination as claimed in claim 1, wherein said means for extracting energy is a maintained in the buoyant body (shell); another is a mooring which may be temporary or permanent. A third element, which is a reactionary moving weight, attached to the free end of the flexible member. Said weight is scaled to the buoyancy of the WEC's shell, thus serving to the effective scalability and efficiency of the overall device.

3. The combination as claimed in claim 2, wherein the flexible member (tether) is rotationally attached, wrapped and/or warped to a freely rotating cylindrical member as a part of the WEC. The flexible member (tether and/or line) causes a cylindrical member to rotate bi-directionally as the WEC reacts with the water's motion.

4. The combination as claimed in claim 3 wherein the reaction of the WEC is enhanced through the suspended potential kinetic energy of the reactionary free moving weight attached to the free end of the tether connecting the three elements of the device.

5. The combination as claimed in claim 3 wherein the bi-directional rotation of the rotating cylindrical member is converted, by means of a freewheel mechanical device, into a single direction of rotation. Said freewheel device(s) to be implemented so as to capture both directions of rotation of the freely rotating cylindrical member attached to the flexible member (tether).

6. The combination as claimed in claim 4 wherein the flexible member is scaled in its length to match the depth and potential strength of the body of water in which the WEC is placed. A series in plurality of mechanical stops are installed onto the flexible member to prevent the suspended weight from making contact with either the subsurface (land) or the WEC's buoyant body.

7. The combination as claimed in claim 6 wherein the buoyant body of the WEC is placed between the mechanical stops of the flexible member. Said placement shall be such that the WEC's movement along the flexible member should be such that its total available motion shall remain behind the midpoint of its equalizing buoyancy as this is translated via the flexible member.

8. The combination as claimed in claim 7 wherein the flexible member is constructed of a neutral buoyancy material. Said material shall also have a stretchable and/or spring-like nature thus furthering the effectiveness in recovering relative linear motion between the elements of the apparatus. The material's nature shall also assist in lowering impact loading upon the system.

9. The combination as claimed in claim 7, wherein the mass of the freely suspended weight, attached to the free end of the flexible member, shall have sufficient potential kinetic energy so as to assist the WEC to return to the forward mechanical stop located on the flexible member.

10. The combination as claimed in claim 7, wherein the mechanical stops on the flexible member shall be designed so as to minimize shock loads as the buoyant shell reaches the end of travel, along same, by means of the rotating cylindrical body.

11. The combination as claimed in claim 5, wherein said mechanical means for utilizing the single direction rotational output of the freewheel device(s) is connected to an energy collection device(s) such as an electrical generator or pump.

12. The combination as claimed in claim 10 including a means for enhancing the characteristics of the rotation, wherein a flywheel(s) and/or mechanical transmission(s) is utilized to maintain and/or increase the speed of rotation supplied by the freewheel device(s) via input from the cylindrical body attached to the flexible member.

13. A combination as claimed in claim 5 wherein the freely rotating cylindrical member is substantially low in mass to minimize flywheel torque allowing for quick change in rotational direction.

14. The combination as claimed in claim 12, wherein said the low mass cylindrical member transfers its rotation in a single direction of rotation through the use of freewheel devices to flywheels of substantially high mass to increase their flywheel torque to assist in maintaining the output rotation in singular direction.

15. The combination as claimed in claim 13, wherein said flywheels contain a means for coupling their rotational energy to other devices which may easily translate their energy into useful work via electrical generation or pumping devices which may contain a mechanical or hydraulic transmission for enhancing said mechanical motion. These devices shall be referred to as power-takeoff-units (PTO) in further descriptions.
